(19) United States
(12) Patent Application Publication
(10) Pub. No.: US 2013/0325335 A1
(43) Pub. Date: Dec. 5, 2013

(54) METHOD FOR IDENTIFYING AN ECO-ROUTE USING A STATE OF CHARGE CONSUMPTION RATIO

(71) Applicants: HYUNDAI MOTOR COMPANY, Seoul (KR); KIA MOTORS CORPORATION, Seoul (KR)

(72) Inventors: Jungdo Kee, Seoul (KR); Seunggil Choi, Yongin (KR); Jaeok Lee, Seongnam (KR)

(73) Assignees: KIA MOTORS CORPORATION, Seoul (KR); HYUNDAI MOTOR COMPANY, Seoul (KR)

(21) Appl. No.: 13/705,501

(22) Filed: Dec. 5, 2012

(30) Foreign Application Priority Data
Jun. 5, 2012 (KR) 10-2012-0060460

(51) Int. Cl. G01C 21/34

(52) U.S. Cl. CPC G01C 21/3469
USPC 701/527; 701/400

(57) ABSTRACT

The present disclosure provides a method for determining an eco-route using a state of charge (SOC) consumption ratio that includes an eco-driving logic for an electric vehicle configured to apply a cost function to select an eco-route in a navigation system, decide an optimal eco-route of the cost function from an SOC ratio map having information on a mileage with respect to an SOC consumption ratio, and provide the determined optimal eco-route as a travel route of the electric vehicle.

### CROSS-REFERENCE TO RELATED APPLICATIONS

This application claims priority under 35 U.S.C. §119(a) to Korean Patent Application No. 10-2012-0060460, filed on Jun. 5, 2012, which is incorporated herein by reference in its entirety.

### BACKGROUND

1. Field of the Invention

The present invention relates to a method for determining a route in an navigation system. More particularly; the present invention relates to a method for determining an eco-route using a state of charge (SOC) consumption ratio, which identifies a route that provides a minimum electricity consumption ratio for an electric vehicle from among a plurality of route candidates.

2. Description of Related Art

Methods for determining a fuel efficient route are known in the art, and may be used to drive a vehicle in an economical manner. In other words, such methods may serve to route selection so as to allow a vehicle to reach a selected destination at a minimum cost in terms of fuel consumption. These route selection methods typically function by selecting a plurality of candidate routes, identifying a route that the vehicle may drive at a minimum cost, and providing the identified route as an eco-route. That is, the method applies a cost function to a plurality of candidate routes identified by a route searching algorithm, calculates costs that are expected to be associated with the respective routes during actual driving, and then selects a route having the minimum cost.

For example, referring to FIG. 1A, each of the candidate routes may be divided into a plurality of sections L, which may be defined as a link between various nodes such as, for example, the junctions A and B. If a vehicle is driven along the divided section L under actual driving conditions, the fuel consumption for the vehicle may be calculated. Accordingly, a cost function may be acquired for calculating a route cost for traveling along the divided section L, and then applied to all of the relevant route sections to calculate a cost function for the corresponding route.

The cost functions calculated for the respective candidate routes may be compared to each other to select a route having the minimum cost as an eco-route, which represents the optimal route.

As illustrated in FIG. 1B, which depicts a velocity-acceleration profile of a vehicle, the divided section L may be divided into an initial acceleration section (a) in which the vehicle accelerates from a standstill, an average-velocity travel section (b) in which the vehicle travels at an average velocity, and a deceleration section (c) in which the vehicle decelerates to a stop. A fuel consumption ratio, which is stored in the form of a table or map for each velocity or acceleration, is applied to the respective sections to calculate the cost function of the divided section L.

For example, as illustrated in FIG. 1C, suppose that when the vehicle is driven at 70 kph(km/h), the vehicle consumes fuel at 18 mg/s, when the vehicle is driven at 80 kph, the vehicle consumes fuel at 20 mg/s, when the vehicle is accelerated at 9 kph/sec to reach 70 kph, the vehicle consumes fuel 25 mg/s, and when the vehicle is accelerated at 9 kph/sec to reach 80 kph, the vehicle consumes fuel at 30 mg/s. In this case, fuel consumption ratios based on the preset velocities and accelerations may be applied to calculate a fuel consumption ratio of the corresponding divided section L, that is, the cost function.

Unfortunately, while the above-described conventional method for determining an eco-route may be applied to a general vehicle using gasoline or diesel as fuel, it cannot be applied to an eco-friendly vehicle, or in particular, to an electric vehicle to which a fuel consumption ratio cannot be applied.

### SUMMARY OF THE DISCLOSURE

The present invention is directed to a method for identifying an eco-route using a state of charge (SOC) consumption ratio, which may be applied to an electric vehicle, and provides a route having the minimum electricity consumption for the electric vehicle.

In another aspect, the present invention is directed to a method for identifying an eco-route using a SOC consumption ratio, which enables an electric vehicle to travel to a selected destination with the minimum amount of electricity consumption, thereby increasing a mileage at which an electric vehicle may be driven on a single charge.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an exemplary embodiment of the present invention, a method for determining an eco-route using a SOC consumption ratio may include an eco-driving logic for an electric vehicle configured to apply a cost function to select an eco-route in a navigation system, decide an optimal eco-route based on the cost function from a SOC ratio map having information on a mileage with respect to a SOC consumption ratio, and provide the identified optimal eco-route as the travel route of the electric vehicle.

The eco-driving logic may include: an information determining step that reads a SOC of a battery mounted in the vehicle from the SOC ratio map, to which the cost function has been previously provided, when a destination is input into the navigation system; a route searching step of searching for a plurality of route candidates for reaching the input destination; a SOC consumption ratio calculation step of substituting the cost function for the plurality of route candidates selected by the navigation system and calculating SOC consumption ratios for the respective candidate routes; and an eco-route determining step of comparing the SOC consumption ratios for the respective candidate routes, calculated at the SOC consumption ratio calculation step, and selecting a route having the minimum SOC consumption ratio as the eco-route.

In the SOC consumption ratio calculation step, the SOC consumption ratios for the respective routes may be calculated based on the supposition that: each of the candidate routes is divided into a plurality of sections; each of the divided sections is then further divided into an initial acceleration section in which the vehicle is accelerated from a standstill to a predetermined velocity, an average velocity travel section in which the accelerated vehicle travels at an average velocity, and a deceleration section in which the traveling vehicle is decelerated; and the vehicle is driven along the initial acceleration section and the average velocity travel section according to previously-stored electricity consumption ratios, respectively.

The average velocity travel section may include: a deceleration section in which the vehicle is temporarily decelerated during travel; and a reacceleration section in which the vehicle is reaccelerated to reach the average travel velocity, after being decelerated. According to an exemplary embodiment, the initial acceleration section may be set in such a manner that the acceleration of the initial acceleration section is controlled by reflecting a driver's disposition.

In the information determination step, traffic information may be received, and in the SOC consumption ratio calculation step, the SOC consumption ratio may be calculated by reflecting the acceleration of the initial acceleration section and the average travel velocity of the average velocity travel section according to the traffic information that has been received.

In the SOC consumption ratio calculation step, each of the candidate routes may be divided into a plurality of sections, and the SOC consumption ratio may be calculated by adding electric power consumptions for each of the plurality of sections to determine the total power generated by a motor of the vehicle, in order to generate a drivability such that the vehicle is driven to overcome travel resistance of the vehicle.

The electric power consumptions are calculated by the following equation:

$$P = \frac{M}{1000} \cdot V \cdot ( a + g \cdot sin θ ) + ( M \cdot g \cdot {C}_{r} + \frac{1}{2} \cdot {V}^{2} \cdot A \cdot {C}_{D} ) \cdot \frac{V}{1000}$$

where P represents the total power, M represents a vehicle weight, V represents a vehicle velocity, a represents an acceleration, g represents an acceleration of gravity, θ represents a road slope, Cᵣ represents a coefficient of rolling resistance of a tire, A represents a front projected area of the vehicle, and CD represents a coefficient of air resistance of the vehicle.

### BRIEF DESCRIPTION OF THE DRAWINGS

FIGS. 1A-1C depict schematic views illustrating a conventional method for deciding an eco-route.

FIG. 2 is a flow chart showing the method for deciding an eco-route in accordance with exemplary embodiments of the present invention.

FIGS. 3A-3C depict schematic views illustrating a method for identifying an eco-route in accordance with a first exemplary embodiment of the present invention.

FIG. 4 illustrates a velocity-acceleration profile in a method for deciding an eco-route in accordance with a second exemplary embodiment of the present invention.

FIG. 5 illustrates a velocity-acceleration profile in a method for deciding an eco-route in accordance with a third exemplary embodiment of the present invention.

FIG. 6 illustrates a velocity-acceleration profile in a method for deciding an eco-route in accordance with a fourth exemplary embodiment of the present invention.

FIG. 7 illustrates a velocity-acceleration profile in a method for deciding an eco-route in accordance with a fifth exemplary embodiment of the present invention.

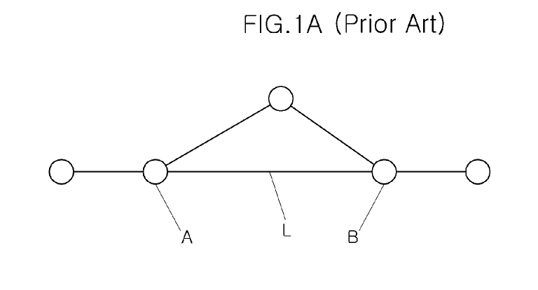

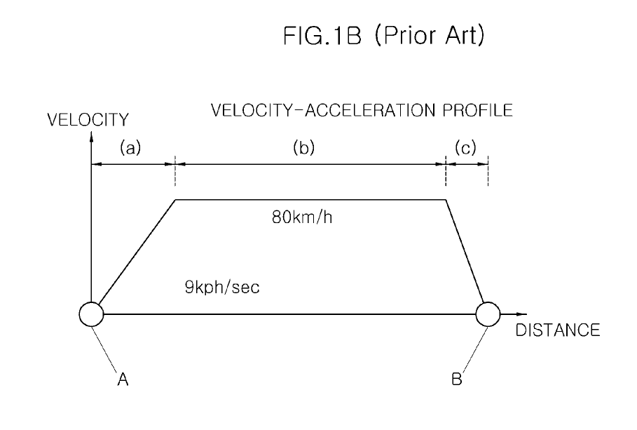

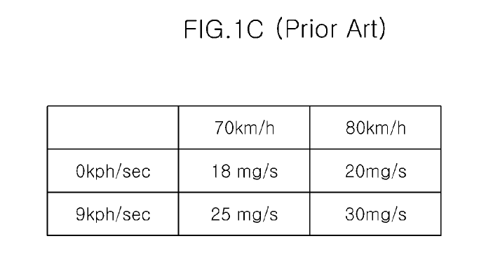

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

A method for determining an eco-route using an SOC consumption ratio in accordance with a first exemplary embodiment of the present invention may include eco-driving logic for an electric vehicle, which applies a cost function to identify and select an eco-route by a navigation system that will allow the vehicle to be driven at a minimum cost (e.g., by minimizing electrical use by the vehicle). For example, the method may determine the eco-route as an optimal route from an SOC ratio map based on mileage information with respect to an SOC consumption ratio in order to acquire the cost function, and then provide the identified eco-route as a driving route of the electric vehicle.

In the SOC ratio map, the SOC ratio is a concept that corresponds to the concept of fuel efficiency for a conventional fuel operated vehicle. In the case of a battery operated vehicle, the SOC ratio may be considered analogous to a fuel efficiency report for a conventional fuel operated vehicle in that the SOC ratio effectively relates “miles traveled” to “electrical consumption” for a battery operated vehicle. In other words, the distance a vehicle may travel by consuming a predetermined amount of electricity (e.g., as represented by SOC) may be referred to as the SOC ratio, and the SOC ratio map may store SOC ratio data for each velocity and acceleration the vehicle may undergo. For example, when the vehicle travels 15 km while consuming 1% of SOC at a specific velocity/acceleration condition, the SOC ratio may be defined as ‘15 km/SOC’, and the SOC ratio map may store the SOC ratio based on the velocity/acceleration condition.

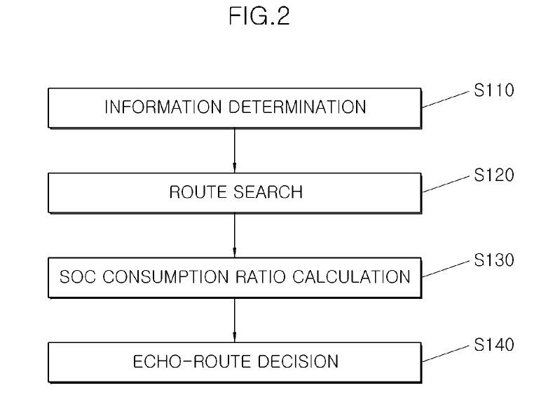

As shown in FIG. 2, the eco-driving logic for an electric vehicle may include: an information determination step S110 of reading the SOC information of the battery of the vehicle from the SOC ratio map, when a destination is input into a navigation system; a route search step S120 of searching for a plurality of candidate routes for the input destination; an SOC consumption ratio calculation step S130 of substituting a cost function for the plurality of candidate routes selected by the navigation system, and calculating SOC consumption ratios for the respective candidate routes; and an eco-route decision step S140 of comparing the SOC consumption ratios for the respective candidate routes, calculated at the SOC consumption ratio calculation step S130, and identifying a candidate route having the minimum SOC consumption ratio as an eco-route.

At the information determination step S110, externally input information is determined. When a destination is input as basic information to the navigation system by a driver, the SOC of the battery of the vehicle is read from the SOC ratio map to which the cost function was previously provided.

Additionally, signals such as a steering angle and an accelerator opening degree, which may be used to determine the velocity, direction, etc., of the vehicle, are input from an ECU of the vehicle and then used for the information determination.

Furthermore, traffic information received through wireless communication, digital broadcasting or the like may be determined to assess traffic information during the route decision. For example, transport protocol expert group (TPEG) information may be received from a DMB network and then used to determine a route.

At route search step S120, the plurality of candidate routes for the input destination may be selected by a route searching algorithm. That is, the plurality of candidate routes may be selected as candidates for a route that is to be ultimately decided for the input destination. Additionally, the route searching algorithm may include a variety of search algorithms known to those skilled in the art.

At the SOC consumption ratio calculation step S130, the cost function is substituted for the plurality of candidate routes, which are primarily determined for the input destination by the navigation system, in order to calculate the SOC consumption ratios for the respective routes.

At the SOC calculation ratio step S130, the SOC consumption ratios are calculated by applying the cost function to the respective candidate routes determined at route search step S120. At this time, the SOC ratio map may be applied to calculate the SOC consumption ratios for each of the respective routes.

At eco-route decision step S140, the SOC consumption ratios for the respective routes, calculated at the SOC consumption ratio calculation step S130, may be compared to each other to select a route having the minimum SOC consumption ratio as a final route.

At the SOC calculation ratio step S130, the SOC ratio map may be applied to the respective candidate routes identified at the route search step S120, in order to calculate electricity consumptions for each of the respective candidate routes. In such a state where the electricity consumptions for each of the respective candidate routes, that is, the SOC consumption ratios are calculated, a candidate route having the minimum electricity consumption may be selected as the final route.

As the SOC ratio map is applied to one of the paths decided at the route search step S120, the final route may be selected as an eco-route in which the vehicle consumes the minimum SOC to reach the destination. In other words, when the driver drives the vehicle along the selected eco-route, the vehicle may reach the destination with the minimum SOC consumption.

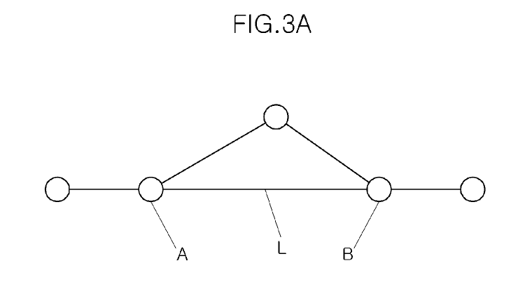

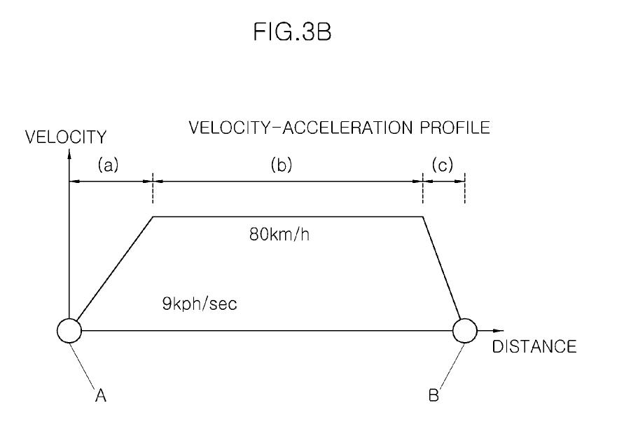

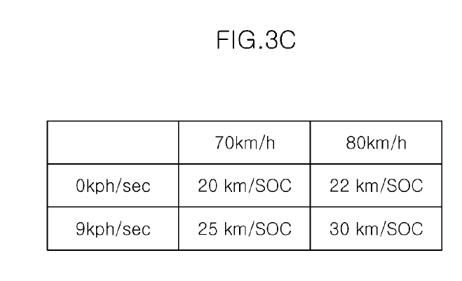

The SOC consumption ratio calculation step S130 will be described in detail as follows. As shown in FIG. 3, the SOC consumption ratio calculation step S130 in the method for determining an eco-route using an SOC consumption ratio in accordance with a first exemplary embodiment of the present invention, a divided section L between two nodes A and B on a preset route (see, e.g., FIG. 3A) may be divided into an initial acceleration section (a), an average velocity travel section (b), and a deceleration section (c), as illustrated in FIG. 3B. Furthermore, an SOC consumption ratio required for driving an electric vehicle may be calculated on the supposition that the electric vehicle is driven at a constant acceleration and velocity along the initial acceleration section (a) and the average velocity travel section (b) on a velocity-acceleration profile of the divided section L.

For example, suppose that the vehicle is driven at a constant SOC consumption ratio along the initial acceleration section (a) and the average velocity travel section (b), a cost function required for traveling the corresponding divided section L, that is, the SOC consumption ratio may be calculated. In a conventional method, the fuel consumption ratio may be applied to the acceleration section and the average velocity travel section. In this exemplary embodiment of the present invention, however, the electricity consumption ratio may be applied to set the cost function of the divided section L.

For example, as shown in FIG. 3C, when the average travel velocity at the average velocity travel section (b) is 70 km/h, the vehicle may consume electricity at 20 km/SOC, and when the average travel velocity is 80 km/h, the vehicle may consume electricity at 22 km/SOC. Furthermore, when the vehicle is accelerated at a constant acceleration, for example, 9 kph/sec, the electricity of the battery may be consumed at 25 km/SOC to reach 70 km/h or at 30 km/SOC to reach 80 km/h. In this case, the reason why the electricity consumption ratio is set to ‘km/SOC’ is in order to set a route using a distance where the vehicle may travel by consuming a predetermined amount of electricity stored in the battery.

Furthermore, the fuel consumption ratio of the conventional method is set to an absolute amount of fuel consumed per predetermined time like ‘mg/s’, regardless of the capacity of a fuel tank. The reason why the electricity consumption ratio is expressed as a distance to empty (DTE) per predetermined charge consumption is in order to calculate a DTE according to an amount of charge consumed from the battery mounted in the electric vehicle, because batteries mounted in different vehicles may have different capacities.

Furthermore, the electricity consumption ratio may be acquired from simulation data and chassis dynamometer data according to the acceleration and velocity, and previously stored in the form of a map.

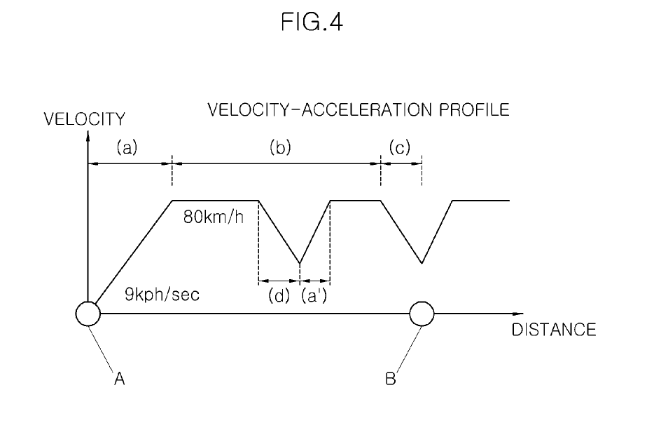

FIG. 4 illustrates a method for determining an eco-route using an SOC consumption ratio in accordance with a second exemplary embodiment of the present invention. Referring to FIG. 4, the SOC consumption ratio calculation step S130 may include a deceleration section (c) and a reacceleration section (a) in the average velocity travel section (b).

While a vehicle is driven, a case may arise in which the vehicle is temporarily decelerated in a temporary deceleration section (d), and then reaccelerated (e.g., cornering or changing multiple lanes). Therefore, when the divided section of the decided route candidate includes an element to interfere with the average velocity travel in the average velocity travel section (b), that is, cornering or changing multiple lanes at a predetermined turning radius or less as illustrated in the velocity-acceleration profile of FIG. 4, the deceleration section (c) and the reacceleration section (a) are set to take into account the driving condition of the vehicle, and then reflected to calculate the SOC consumed for driving the vehicle.

At this time, the acceleration of the reacceleration section (a′) may be set differently from the acceleration of the initial acceleration section (a). That is, in the initial acceleration section (a), the vehicle may be accelerated to reach the average velocity travel section (b) from a standstill state. In the reacceleration section (a′), however, the vehicle may be accelerated to reach the average velocity travel section (b) from a state in which the velocity of the vehicle is temporarily reduced. Therefore, the acceleration of the initial acceleration section (a) does not need to be equal to the acceleration of the reacceleration section (a′).

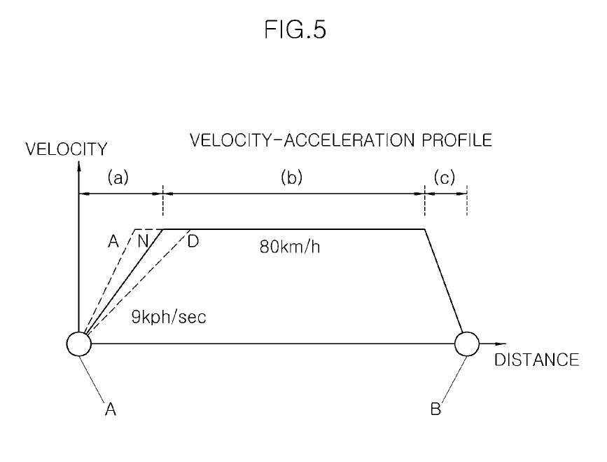

FIG. 5 illustrates a method for deciding an eco-route using an SOC consumption ratio in accordance with a third exemplary embodiment of the present invention in which electricity consumption may be calculated by reflecting a driver's disposition into the initial acceleration section (a).

When typical acceleration is prepared depending on a driver's disposition (e.g., driving tendencies, or driving style), an SOC consumption ratio may be calculated by considering whether the driver accelerates a vehicle rapidly or slowly. For example, the vehicle may include a steering angle sensor to sense the degree of manipulation of the steering wheel, and an acceleration pedal sensor to sense whether an acceleration pedal is depressed or not, and the driver's disposition may be determined by reflecting information input from the steering angle sensor or the acceleration pedal sensor.

Depending on the driver's disposition, an aggressive mode (D1), a normal mode D2, or a defensive mode D3 may be applied to differentially set the acceleration of the initial acceleration section (a) in the velocity-acceleration profile of FIG. 5. For example, the determined driver's disposition may be considered to suppose that the vehicle is accelerated at 10 kph/sec in the aggressive mode, at 7 kph/sec in the normal mode, and at 5 kph/sec in the defensive mode, in the initial acceleration section (a). Electricity consumptions based on the respective cases may be applied to calculate an electricity consumption for the divided section L of the corresponding route candidate.

At this time, the electricity consumptions in the respective modes increase with the increase of the acceleration. Therefore, a predetermined value may be used as the electricity consumption for the corresponding acceleration. In this exemplary embodiment of the present invention, the driver's disposition may be divided into three modes. However, the three modes may be subdivided into various modes, and accelerations of the respective modes may be differently set.

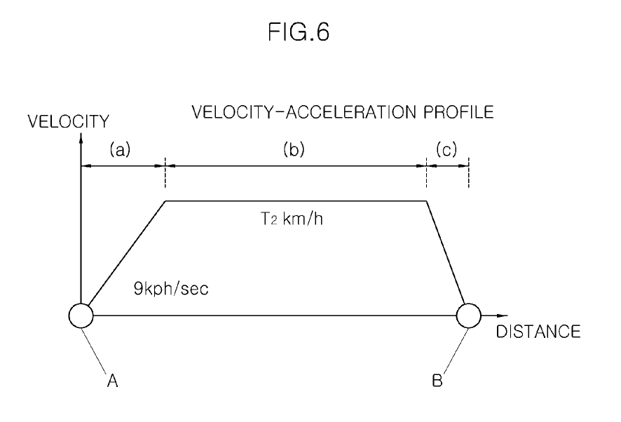

FIG. 6 illustrates a method for determining an eco-route using an SOC consumption ratio in accordance with a fourth exemplary embodiment of the present invention in which traffic information may be reflected to calculate the SOC consumption ratio of the corresponding section at the SOC consumption ration calculation step S130.

Recently, traffic information can be received through wireless communication or digital broadcasting, even while driving. In particular, most navigation systems are set to receive TPEG information. Therefore, the received TPEG information may be utilized to calculate an electricity consumption of the corresponding divided section of the route candidate, that is, an SOC consumption ratio.

According to the received traffic information, the acceleration (T1 kph/sec) of the initial acceleration period (a) and the acceleration (T2 km/h) of the average velocity travel section (b) in the corresponding divided section may be decided on the velocity-acceleration profile of FIG. 6, and SOC consumption required for traveling the corresponding divided section may be calculated according to an SOC consumption ratio corresponding to the acceleration and the average travel velocity. As described above, the electricity consumption may be calculated by reflecting the traffic information into the decided route candidate.

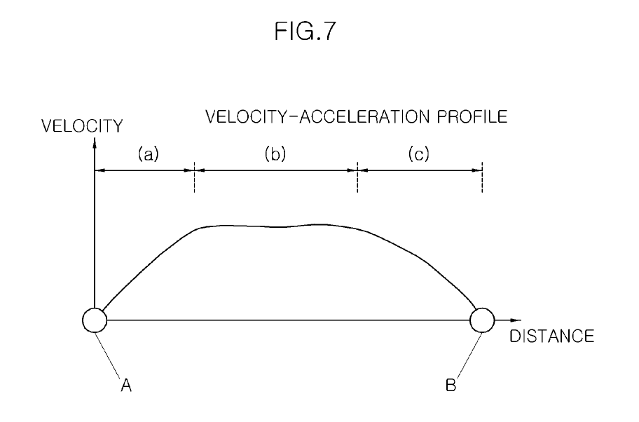

FIG. 7 illustrates a method for determining an eco-route using an SOC consumption ratio in accordance with a fifth embodiment of the present invention.

In a fifth exemplary embodiment of the present invention, the acceleration-velocity profile may be implemented as a dynamic model instead of a static model. For example, the acceleration-velocity profile may be configured as illustrated in FIG. 7 so as to set the initial acceleration section (a), the average velocity travel section (b), and the deceleration section (c). At this time, an SOC consumption ratio does not have a static form as illustrated in FIGS. 3 to 6, but rather has a dynamic form which may be similar to a driving situation on an actual road.

Therefore, as illustrated in FIG. 7, the divided section may be divided into the initial acceleration section (a), the average velocity travel section (b), and the deceleration section (c). As described above, however, the divided section may not be clearly divided.

In this embodiment of the present invention, when an electricity consumption ratio is calculated, a predetermined electricity consumption ratio such as ‘km/SOC’ is generally not used during average velocity travel or acceleration, but rather the

$$P = \frac{M}{1000} \cdot V \cdot ( a + g \cdot sin θ ) + ( M \cdot g \cdot {C}_{r} + \frac{1}{2} \cdot {V}^{2} \cdot A \cdot {C}_{D} ) \cdot \frac{V}{1000}$$

electricity consumption ratio may be determined based on total power which is generated by a motor such that the vehicle overcomes resistance occurring during travel.

For example, the electricity consumption ration based on the total power may be calculated by the following equation which corresponds to a power consumption model indicating an accumulated amount of electric power consumption.

Here, P represents the total power, M represents a vehicle weight, V represents a vehicle velocity, a represents an acceleration, g represents an acceleration of gravity, θ represents a road slope, Cᵣ represents a coefficient of rolling resistance of a tire, A represents a front projected area of the vehicle, and C_{D} represents a coefficient of air resistance of the vehicle.

Furthermore, the above-described equation may be set to a basic dynamic model of eco-driving, which may be applied to an electric vehicle. As the acceleration/deceleration sections, the driver's disposition, the traffic information may be reflected to apply tuning coefficients, the equation may be modified.

In accordance with the embodiments of the present invention, while the navigation system selects a route to a destination, the route may be selected according to a method suitable for an electric vehicle.

Furthermore, as the route suitable for the electric vehicle is selected, it is possible to increase a mileage at which the electric vehicle may be driven on a single charge.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

While the present invention has been described with respect to the specific embodiments, it will be apparent to those skilled in the art that various changes and modifications may be made without departing from the spirit and scope of the invention as defined in the following claims.

What is claimed is:

1. A method for determining an eco-route for an electric vehicle, comprising:
identifying, at a navigation system, one or more potential routes from a location to a destination;
applying a cost function algorithm to the one or more potential routes, wherein the cost function algorithm correlates each of the one or more potential routes with a battery cost;
identifying an optimal eco-route between the location and the destination; and
providing the optimal eco-route as a travel route for the electric vehicle.

2. The method of claim 1, wherein the cost function algorithm correlates mileage of each of the one or more potential routes with a state-of-charge (SOC) consumption ratio for a battery of the vehicle to generate the battery cost.

3. The method of claim 2, wherein the cost function algorithm generates a SOC ratio map.

4. The method of claim 3, further comprising;
reading a SOC of a battery mounted in the vehicle from the SOC ratio map.

5. The method of claim 2, further comprising:
substituting the cost function for each of the one or more potential routes selected by the navigation system;
calculating SOC consumption ratios for each of the one or more potential routes;
comparing the SOC consumption ratios for each of the one or more potential routes; and
selecting a route having the minimum SOC consumption ratio as the eco-route.

6. The method of claim 5, wherein the SOC consumption ratio is calculated by dividing each of the one or more potential routes into a plurality of sections including an initial acceleration section, an average velocity section, and a deceleration section, and combining a SOC ratio for each section to generate the SOC consumption ratio.

7. The method of claim 6, wherein the average velocity travel section comprises a deceleration sub-section and a reacceleration sub-section.

8. The method of claim 6, wherein the initial acceleration section is set so as to conform with a driving style of a driver.

9. The method of claim 1, wherein the cost function algorithm further correlates each of the one or more potential routes with a traffic cost.

10. The method of claim 9, wherein the traffic cost is based on traffic information received by the vehicle.

11. The method of claim 10, wherein the traffic information is TPEG information.

12. The method of claim 6, wherein the SOC consumption ratio is calculated by accumulating electric power consumptions for each of the sections and indicating total power generated by a motor of the vehicle.

13. The method of claim 12, wherein the vehicle is driven to overcome travel resistance of the vehicle.

14. The method of claim 13, wherein the electric power consumptions are calculated by the following equation:
$$P = \frac{M}{1000} \cdot V \cdot ( a + g \cdot sin θ ) + ( M \cdot g \cdot {C}_{r} + \frac{1}{2} \cdot {V}^{2} \cdot A \cdot {C}_{D} ) \cdot \frac{V}{1000}$$
where P represents total power, M represents a vehicle weight, V represents a vehicle velocity, “a” represents an acceleration, “g” represents an acceleration of gravity, θ represents a road slope, Cᵣ represents a coefficient of rolling resistance of a tire, “A” represents a front projected area of the vehicle, and C_{D} represents a coefficient of air resistance of the vehicle.

15. A non-transitory computer readable medium containing program instructions executed by a controller for calculating an eco-route, the computer readable medium comprising:
program instructions that identify, at a navigation system, one or more potential routes from a location to a destination;
program instructions that apply a cost function algorithm to the one or more potential routes, wherein the cost function algorithm correlates each of the one or more potential routes with a battery cost;
program instructions that identify an optimal eco-route between the location and the destination; and
program instructions that provide the optimal eco-route as a travel route for the electric vehicle.
